(19) United States
(12) Patent Application Publication
(10) Pub. No.: US 2018/0170070 A1
(43) Pub. Date: Jun. 21, 2018

(54) PRINTING APPARATUS AND HEATING METHOD

(71) Applicant: SEIKO EPSON CORPORATION, Tokyo (JP)

(72) Inventor: Yuki MORIYA, Shiojiri-shi (JP)

(21) Appl. No.: 15/840,864

(22) Filed: Dec. 13, 2017

(30) Foreign Application Priority Data
Dec. 19, 2016 (JP) 2016-245555

(51) Int. Cl. B41J 11/00

(52) U.S. Cl. CPC B41J 11/002

(57) ABSTRACT

A printing apparatus includes a printing unit that performs printing on a medium and a heating unit that heats the medium in a heating region. The heating region includes a first portion and a second portion having a height lower than the first portion in a direction of gravity, and the heating unit is configured such that an amount of heat per unit area applied to the second portion is greater than an amount of heat per unit area applied to the first portion.

### BACKGROUND

### 1. Technical Field

The present invention relates to a printing apparatus and a heating method.

### 2. Related Art

To date, various printing apparatuses have been used. Among them, there are printing apparatuses that include a heating unit (a so-called pre-heater) that heats a medium before printing is performed by a printing unit, a heating unit (a so-called print heater) that heats a medium in a printing area of the printing unit, and a heating unit (a so-called after-heater) that heats a medium after printing is performed by the printing unit.

For example, JP-A-2004-181815 discloses an image forming apparatus (printing apparatus) including an after-heater formed of a heating wire serving as a heating unit.

In the image forming apparatus disclosed in JP-A-2004-181815, a heating wire (after-heater) is provided in a portion where the downstream side in the transport direction of a medium (a recording medium) is low. The arrangement density of the electric heating wire decreases toward the downstream side in the transport direction. That is, in the image forming apparatus disclosed in JP-A-2004-181815, a heating wire is provided such that the arrangement density is higher as a portion thereof is located higher and the arrangement density is lower as a portion thereof is located lower. Due to the fact that hot air, which has a low density, rises, in the image forming apparatus disclosed in JP-A-2004-181815, the heat applied to the medium greatly differs between the upstream side in the transport direction and the downstream side in the transport direction (on the upstream side in the transport direction, the medium is heated at a high temperature and on the downstream side in the transport direction, the medium is heated at a low temperature). Due to such a configuration of the heating unit, the temperature difference in the heating region becomes large, and the medium may be unevenly heated in some cases.

### SUMMARY

An advantage of some aspects of the invention is that uneven heating of a medium by a heating unit is suppressed.

A printing apparatus according to an aspect of the invention includes a printing unit that performs printing on a medium and a heating unit that heats the medium in a heating region. The heating region includes a first portion and a second portion having a height lower than the first portion in a direction of gravity, and the heating unit is configured such that the amount of heat per unit area applied to the second portion is greater than the amount of heat per unit area applied to the first portion.

According to this aspect, the amount of heat per unit area applied to the second portion disposed at a lower height in the direction of gravity is larger than the amount of heat per unit area applied to the first portion disposed at a higher height in the direction of gravity. Because hot air, which has a low density, rises, hot air moves from the second portion side to the first portion side and it is therefore possible to reduce the temperature difference in the heating region and suppress uneven heating of the medium by the heating unit.

Further, the “first portion” and the “second portion” mean, for example, that when the heating region is divided into two in the direction of gravity, the higher-side region can be referred to as the “first portion” and the lower-side region can be referred to as the “second portion”.

In the printing apparatus, the heating region may include a convection space in which air circulates between the first portion and the second portion.

According to this aspect, because the convection space in which air circulates between the first portion and the second portion is provided, the temperature difference in the heating region can be reduced particularly effectively.

In the printing apparatus, the convection space may have a first surface along the support surface of the medium and a second surface parallel to the first surface.

According to this aspect, because the convection space has the first surface and the second surface parallel to the first surface, the convection space can be provided along the support surface and the volume can be reduced. Therefore, it is possible to circulate hot air particularly efficiently in the convection space.

Further, it should be noted that “the second surface parallel to the first surface” means not only a case where it is parallel in a strict sense but also a case where it is deviated somewhat from parallel.

In the printing apparatus, the convection space may include an air blowing unit.

According to this aspect, because the air blowing unit is provided in the convection space, it is possible to circulate the hot air particularly efficiently in the convection space.

In the printing apparatus, the heating unit may be configured such that the arrangement density of the heat source that heats the second portion is higher than the arrangement density of the heat source that heats the first portion.

According to this aspect, the arrangement density of the heat source that heats the second portion is higher than the arrangement density of the heat source that heats the first portion. Therefore, it is possible to easily form a configuration in which the amount of heat per unit area applied to the second portion having a lower height in the direction of gravity is larger than the amount of heat per unit area applied to the first portion having a higher height in the direction of gravity.

In the printing apparatus, the heating unit may not include the heat source that heats the first portion.

According to this aspect, because the heat source that heats the first portion is not disposed in the heating unit, a configuration in which the arrangement density of the heat source that heats the second portion is higher than the arrangement density of the heat source that heats the first portion is particularly easy to form.

The printing apparatus may further include, as the heating unit, a pre-heater that heats the medium before printing is performed by the printing unit.

According to this aspect, it is possible to heat the medium while suppressing uneven heating before printing is performed by the printing unit.

The printing apparatus may further include, as the heating unit, a print heater that heats the medium while printing is performed by the printing unit.

According to this aspect, it is possible to heat the medium while suppressing uneven heating in the printing area of the printing unit while printing is performed by the printing unit.

The printing apparatus may further include, as the heating unit, an after-heater that heats the medium after printing is performed by the printing unit.

According to this aspect, it is possible to heat the medium while suppressing uneven heating after printing is performed by the printing unit.

A heating method according to another aspect of the invention is a heating method for a printing apparatus that includes a printing unit that performs printing on a medium and a heating unit that heats the medium in a heating region including a first portion and a second portion having a height lower than the first portion in the direction of gravity. The method includes heating the medium with the heating unit such that an amount of heat per unit area applied to the second portion is greater than an amount of heat per unit area applied to the first portion.

According to this aspect, the amount of heat per unit area applied to the second portion disposed at a lower height in the direction of gravity becomes larger than the amount of heat per unit area applied to the first portion disposed at a higher height in the direction of gravity. Because hot air, which has a low density, rises, hot air moves from the second portion side to the first portion side and it is therefore possible to reduce the temperature difference in the heating region and suppress uneven heating of the medium by the heating unit.

### BRIEF DESCRIPTION OF THE DRAWINGS

The invention will be described with reference to the accompanying drawings, wherein like numbers reference like elements.

FIG. 1 is a schematic side view of a printing apparatus according to a first embodiment of the invention.

FIG. 2 is a block diagram of the printing apparatus according to the first embodiment of the invention.

FIG. 3 is a schematic plan view of a main portion (pre-heater) of the printing apparatus according to the first embodiment of the invention.

FIG. 4 is a schematic plan view of a main portion (after-heater) of the printing apparatus according to the first embodiment of the invention.

FIG. 5 is a schematic side view of a main portion (after-heater) of the printing apparatus according to the first embodiment of the invention.

FIG. 6 is a schematic plan view of a main portion (after-heater) of the printing apparatus according to a second embodiment of the invention.

FIG. 7 is a schematic side view of a main portion of the printing apparatus according to a third embodiment of the invention.

### DESCRIPTION OF EXEMPLARY EMBODIMENTS

Hereinafter, a printing apparatus according to an embodiment of the invention will be described in detail with reference to the accompanying drawings.

### First Embodiment

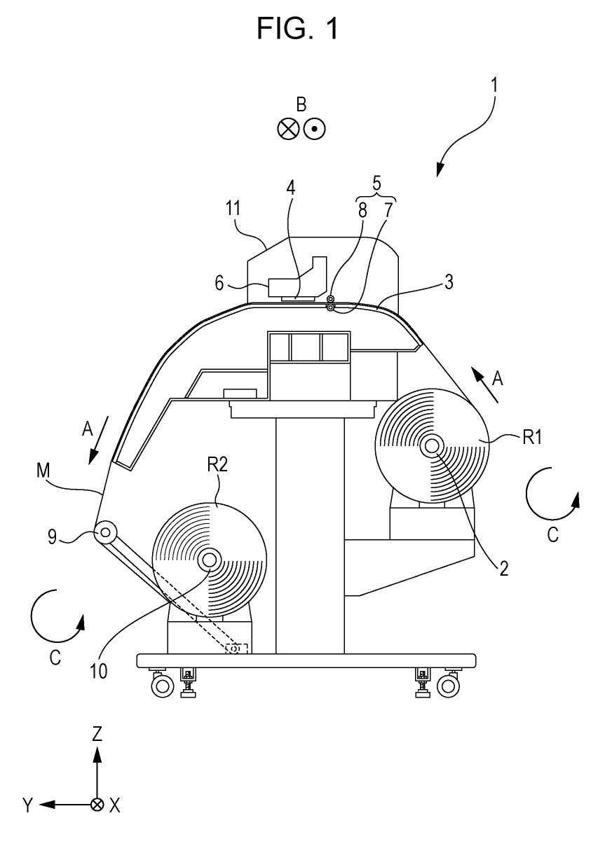

### FIGS. 1 to 5

First, an overview of a printing apparatus according to a first embodiment of the invention will be described. FIG. 1 is a schematic side view of a printing apparatus 1 according to this embodiment.

The printing apparatus 1 of this embodiment is provided with a support shaft 2 for supporting a roll R1 of a medium M of the roll type to be recorded on. In the printing apparatus 1 of this embodiment, when a medium M is transported in the transport direction A, the support shaft 2 rotates in the rotation direction C. Further, in this embodiment, a medium M of the roll type wound such that the printing side faces outward is used; however, in the case where a medium M of the roll type wound such that the printing side faces inward is used, the support shaft 2 can be made to rotate in the opposite direction to the rotation direction C of the support shaft 2 to feed out the roll R1.

In addition, although the printing apparatus 1 of this embodiment uses a roll-type medium as the medium M, it is not limited to a printing apparatus using such a roll-type medium. For example, a single-cut type medium may be used.

In addition, the printing apparatus 1 according to this embodiment is provided with a medium supporting portion 3 for supporting the medium M. Furthermore, the printing apparatus 1 of this embodiment includes a transport roller pair 5 formed of a driving roller 7 and a driven roller 8 for transporting the medium M in the transport direction A in a transport path of the medium M, the transport path being formed of the medium supporting portion 3 and the like.

Further, in the printing apparatus 1 of the embodiment, the driving roller 7 is formed of a single roller that extends in the scanning direction B that intersects the transport direction A of the medium M and the driven roller 8 is provided as a plurality of rollers side by side in the scanning direction B at positions facing the driving roller 7.

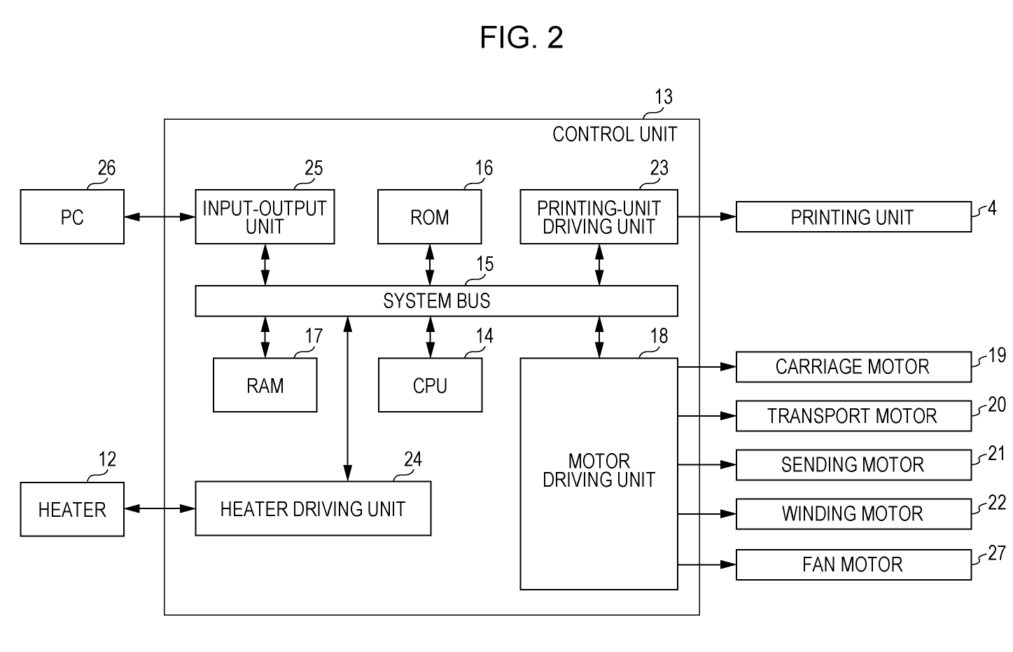

A heater 12 (see FIGS. 2 to 5) formed of a heating wire serving as a heating unit capable of heating the medium M supported by the medium supporting portion 3 is provided in a lower portion of the medium supporting portion 3. In this way, the printing apparatus 1 of this embodiment is provided with the heater 12 capable of heating the medium M from the medium supporting portion 3 side; however, the printing apparatus 1 may be provided with an infrared heater or the like at a position that faces the medium supporting portion 3.

Further, the detailed configuration of the heater 12, which is a main portion of the printing apparatus 1 of this embodiment, will be described later.

In addition, the printing apparatus 1 of this embodiment further includes, inside a housing portion 11, a printing unit 4 as an inkjet head that records by ejecting ink from nozzles of a nozzle forming surface on which a plurality of nozzles are provided and a carriage 6 having the printing unit 4 mounted thereon and capable of reciprocating in the scanning direction B.

Further, in the printing apparatus 1 of this embodiment, the transport direction A of the medium M at a position facing the printing unit 4 (nozzle forming surface) on the medium supporting portion 3 is a direction along a direction Y, which is a horizontal direction, and the scanning direction B of the printing unit 4 is a horizontal direction and is a direction along a direction X orthogonal to the direction Y, and the ink ejecting direction is a direction (vertically downward direction) along a direction Z, which is a vertical direction.

Here, it is possible for the printing unit 4 to print by ejecting ink from nozzles (not illustrated) to the medium M being transported while reciprocating in the scanning direction B intersecting the transport direction A of the medium M. By including the printing unit 4 having such a configuration, as a result of the printing apparatus 1 of this embodiment repeating an operation of causing the medium M to be transported by a predetermined amount (for one pass) in the transport direction A and ejecting ink while moving the printing unit 4 in the scanning direction B in a state where the medium M is stopped, it is possible to form a desired image on the medium M.

Further, note that the printing apparatus 1 of this embodiment is a so-called serial printer that performs printing by alternately repeating the transporting of the medium M and the scanning of the printing unit 4; however, it may be a so-called line printer that performs continuous printing using a line head in which nozzles are formed in a line along the width direction of the medium M while continuously transporting the medium M.

In addition, a winding shaft 10 capable of winding the medium M as a roll R2 is included on the downstream side of the printing unit 4 in the transport direction A of the medium M. Further, in this embodiment, because the medium M is wound up such that the printed surface is outward, when winding up the medium M, the winding shaft 10 rotates in the rotation direction C. On the other hand, when the winding shaft 10 winds up the medium M such that the printed surface is on the inside, it is possible to wind up by rotating in the opposite direction to the rotation direction C.

In addition, a tension bar 9 that extends in the scanning direction B between the downstream end portion of the medium supporting portion 3 in the transport direction A and the winding shaft 10 and that is capable of imparting a desired tension to the medium M is provided.

Next, the electrical structure of the printing apparatus 1 of this embodiment will be described.

FIG. 2 is a block diagram of the printing apparatus 1 of this embodiment.

A control unit 13 is provided with a CPU 14 that controls the entirety of the printing apparatus 1. The CPU 14 is connected, via a system bus 15, to a ROM 16 that stores individual control programs and the like that the CPU 14 performs and a RAM 17 that is capable of temporarily storing data.

The CPU 14 is connected, through the system bus 15, to a printing-unit driving unit 23 that drives the printing unit 4.

In addition, the CPU 14 is connected, via the system bus 15, to a motor driving unit 18 that is connected to a carriage motor 19, a transport motor 20, a sending motor 21, a winding motor 22, and a fan motor 27.

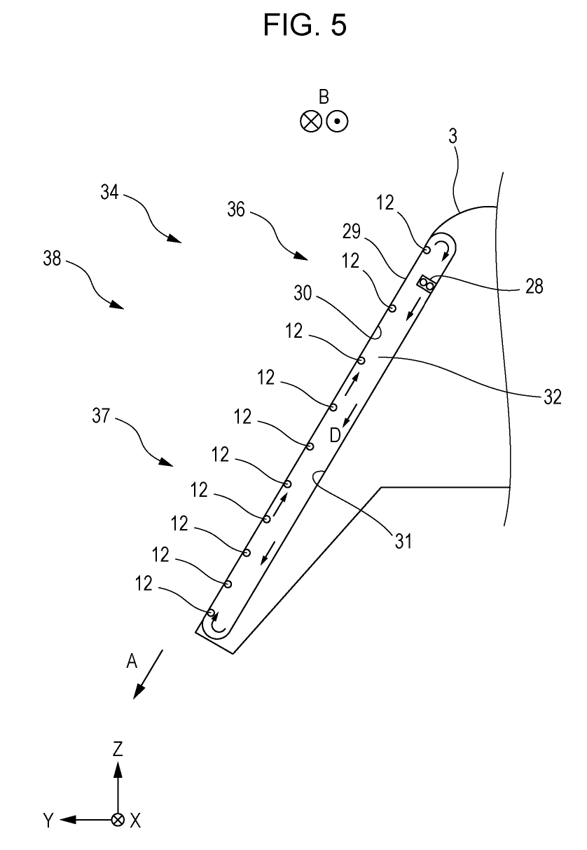

Here, the carriage motor 19 is a motor for moving the carriage 6 on which the printing unit 4 is mounted in the scanning direction B. In addition, the transport motor 20 is a motor for driving the driving roller 7 constituting the transport roller pair 5. In addition, the sending motor 21 is a rotation mechanism of the support shaft 2 and is a motor that drives the support shaft 2 in order to send out the medium M to the transport roller pair 5. In addition, the winding motor 22 is a motor that causes the winding shaft 10 to rotate. The fan motor 27 is a driving motor for driving a fan 28 (refer to FIG. 5) serving as an air blowing unit to be described later.

In addition, the CPU 14 is connected, through the system bus 15, to a heater driving unit 24 for driving the heater 12.

Furthermore, the CPU 14 is connected, through the system bus 15, to an input-output unit 25 that is connected to a PC 26 for performing transmission and reception of data, such as recording data, and signals.

Next, the heater 12 which is a main portion of the printing apparatus 1 of this embodiment will be described.

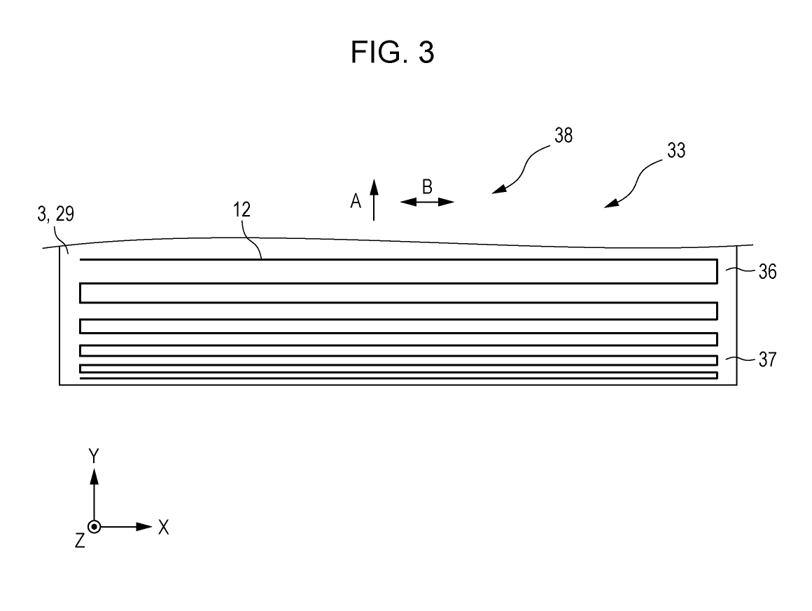

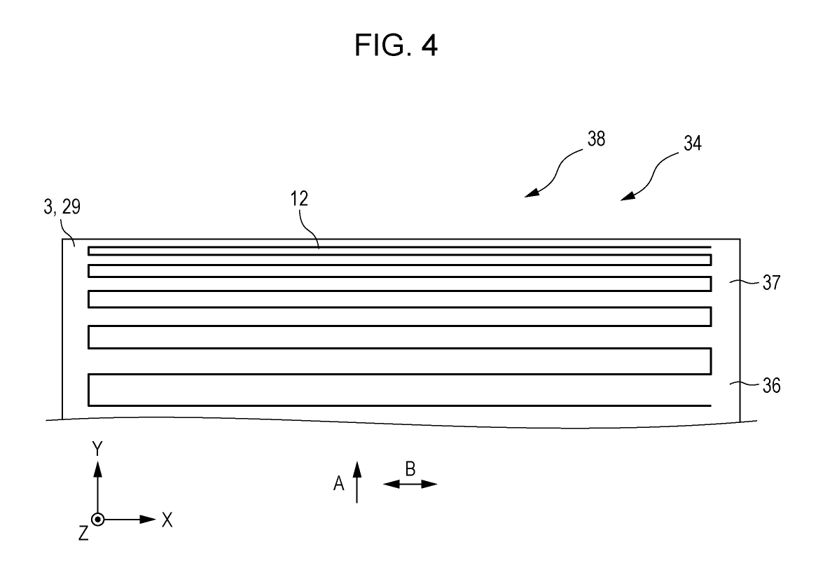

Here, FIG. 3 is a schematic plan view illustrating a pre-heater 33 serving as the heater 12 which is a main portion of the printing apparatus 1 of this embodiment. In addition, FIG. 4 is a schematic plan view showing an after-heater 34 serving as the heater 12 which is a main portion of the printing apparatus 1 of this embodiment. Further, FIG. 5 is a schematic side view showing the after-heater 34 serving as the heater 12 which is a main portion of the printing apparatus 1 of this embodiment. As illustrated in FIG. 5, the heater 12 is provided under the medium supporting portion 3 (a support surface 29); however, in FIGS. 3 and 4, the arrangement of the heaters 12 is illustrated in perspective so as to be easily understood.

As illustrated in FIG. 1, regarding the medium supporting portion 3 of the printing apparatus 1 of this embodiment, from the support shaft 2 to a position (printing area) that faces the printing unit 4 (nozzle forming surface), which is a heating region 38 heated by the pre-heater 33, the upstream side in the transport direction A is low and the downstream side in the transport direction A is high. On the other hand, from the position that faces the printing unit 4 to the winding shaft 10, which is a heating region 38 heated by the after-heater 34, the upstream side in the transport direction A is high and the downstream side in the transport direction A is low.

As illustrated in FIG. 3, in the heating region 38 heated by the pre-heater 33, the arrangement density of the heater 12 is high on the upstream side in the transport direction A and low on the downstream side in the transport direction A (the interval between adjacent heating wires is narrow on the upstream side in the transport direction A and widens on the downstream side in the transport direction A). On the other hand, as illustrated in FIGS. 4 and 5, in the heating region 38 heated by the after-heater 34, the arrangement density of the heaters 12 is low on the upstream side in the transport direction A and high on the downstream side in the transport direction A (the interval between adjacent heating wires is wide on the upstream side in the transport direction A and narrow on the downstream side in the transport direction A).

That is, the heating region 38 heated by the pre-heater 33 and the heating region 38 heated by the after-heater 34 both include a first portion 36, which is a portion with a high height in the direction of gravity (direction along the direction Z) and a second portion 37, which is a portion where the height in the direction of gravity is low (See FIG. 5), and the amount of heat per unit area provided by the heater 12 is larger in the second portion 37 than in the first portion 36.

Further, in the printing apparatus 1 of this embodiment, the pre-heater 33 and the after-heater 34 have the same configuration except for the lengths in the direction along the transport direction A being different, and the high arrangement density and low arrangement density of the heater 12 in the transport direction A being reversed.

To summarize the printing apparatus 1 of this embodiment, as illustrated in FIGS. 1 and 2, the printing apparatus 1 of this embodiment includes the printing unit 4 for printing on a medium M, and the heater 12 that heats the medium M in the heating region 38 as illustrated in FIGS. 3 to 5. The heating region 38 includes the first portion 36 and the second portion 37 whose height in the direction of gravity is lower than that of the first portion 36, and the heater 12 is configured (arranged) such that the amount of heat per unit area applied to the second portion 37 is larger than the amount of heat per unit area applied to the first portion 36. When the amount of heat is given by such a configuration, the temperature of the air around the second portion 37 is higher than the temperature of the air around the first portion 36. In other words, the air around the second portion 37 is hotter than the air around the first portion 36. Because hot air, which has a low density, rises, hot air moves from the second portion 37 side to the first portion 36 side. Therefore, finally, in the heating region 38, the temperature difference between the first portion 36 and the second portion 37 decreases. Therefore, uneven heating of the medium M by the heater 12 can be suppressed.

That is, as a result of the hot air, which has a low density, rising, because the hot air moves from the second portion 37 side to the first portion 36 side thereby reducing the temperature difference of the heating region 38, it can be said that the heating unevenness of the medium M by the heater 12 is suppressed.

Further, the “first portion 36” and the “second portion 37” mean, for example, that when the heating region 38 is divided into two in the direction of gravity, the higher-side region can be referred to as the “first portion 36” and the lower-side region can be referred to as the “second portion 37”.

Here, in the printing apparatus 1 of this embodiment, even though the heater 12 which is a heating wire serving as a heating unit is used, it is also possible to use a heating unit having another configuration such as an infrared ray irradiation apparatus or a hot air generating apparatus in such a manner that the amount of heat per unit area applied to the second portion 37 is greater than the amount of heat per unit area applied to the first portion 36.

In other words, the method of heating the medium M according to this embodiment is a heating method for a printing apparatus that includes the printing unit 4 that performs printing and the heating region 38 that includes the first portion 36, and the second portion 37 that is lower in the direction of gravity than the first portion 36 including heating the medium M with the heating unit such that the amount of heat per unit area applied to the first portion 36 is higher than the amount of heat per unit area applied to the second portion 37. By using such a heating method, hot air moves from the second portion 37 side to the first portion 36 side, the temperature difference of the heating region 38 can be reduced, and uneven heating of the medium M by the heating unit can be suppressed. Further, the heating method of this embodiment is executed under the control of the control unit 13.

In addition, as illustrated in FIG. 5, a convection space 32 in which air circulates between the first portion 36 and the second portion 37 is provided in the heating region 38 of the printing apparatus 1 of this embodiment. The convection space 32 is provided on the side opposite to the side supporting the medium M in the medium supporting portion 3. The convection space 32 is a closed space in which air can circulate. Further, it should be noted that the closed space here is not limited as long as it is a space enclosed mostly by a wall, and it need not be a completely closed space. At this time, in the convection space 32, the air around the second portion 37 having a relatively high temperature rises toward the first portion 36 and the air around the first portion 36, which has a relatively low temperature, descends toward the second portion 37 side. By utilizing such air convection in the convection space 32, it is possible to suitably reduce the temperature difference between the first portion 36 and the second portion 37.

Therefore, in the printing apparatus 1 of this embodiment, the convection space 32 is provided such that the temperature difference of the heating region 38 can be reduced particularly effectively.

In addition, as illustrated in FIG. 5, the convection space 32 of the printing apparatus 1 of this embodiment has a first surface 30 along the support surface 29 of the medium M and a second surface 31 parallel to the first surface 30. The first surface 30 and the second surface 31 are formed in parallel and the convection space 32 is provided along the support surface 29 to reduce the volume. Consequently, the printing apparatus 1 of this embodiment is configured to be able to circulate hot air particularly efficiently in the convection space 32.

Further, it should be noted that “the second surface 31 parallel to the first surface 30” means not only a case where it is parallel in a strict sense but also a case where it is deviated somewhat from parallel.

Furthermore, as illustrated in FIG. 5, the fan 28 is provided in the convection space 32 of the printing apparatus 1 of this embodiment. Consequently, the printing apparatus 1 of this embodiment is configured to allow hot air to circulate in the direction D particularly efficiently in the convection space.

Further, it should be noted that, as in this embodiment, by constructing the convection space 32 such that the connecting portions between adjacent surfaces do not form an acute angle, it is possible to circulate the hot air particularly efficiently in the convection space 32.

In addition, as illustrated in FIGS. 3 to 5, in the heater 12 of this embodiment, the arrangement density of the heat source that heats the second portion 37 (the region on the low side in the direction of gravity) becomes higher than the arrangement density of the heat source that heats the first portion 36 (the region on the high side in the direction of gravity) (the interval between adjacent heating wires serving as the heater 12 is narrow). Therefore, it is possible to easily form a configuration in which the amount of heat per unit area applied to the second portion 37 having a lower height in the direction of gravity is larger than the amount of heat per unit area applied to the first portion 36 having a higher height in the direction of gravity.

However, the invention is not limited to such a configuration in which the spacing between the heating wires is changed, for example, a configuration in which the output of the heating unit is changed between the first portion 36 and the second portion 37 or a configuration in which the distance from the heating unit to the first portion 36 of the heating region 38 and the distance from the heating unit to the second portion 37 of the heating region 38 are different may be used.

In addition, as illustrated in FIG. 3, the printing apparatus 1 of this embodiment includes the pre-heater 33 that heats the medium M before printing is performed by the printing unit 4 as the heater 12. With such a configuration, the printing apparatus 1 of this embodiment can heat the medium M while suppressing uneven heating before printing is performed by the printing unit 4.

In addition, as illustrated in FIGS. 4 and 5, the printing apparatus 1 of this embodiment includes, as the heater 12, the after-heater 34 that heats the medium M after printing is performed by the printing unit 4. With such a configuration, the printing apparatus 1 of this embodiment can heat the medium M while suppressing uneven heating after printing is performed by the printing unit 4.

Next, embodiments other than the above first embodiment will be described.

### Second Embodiment

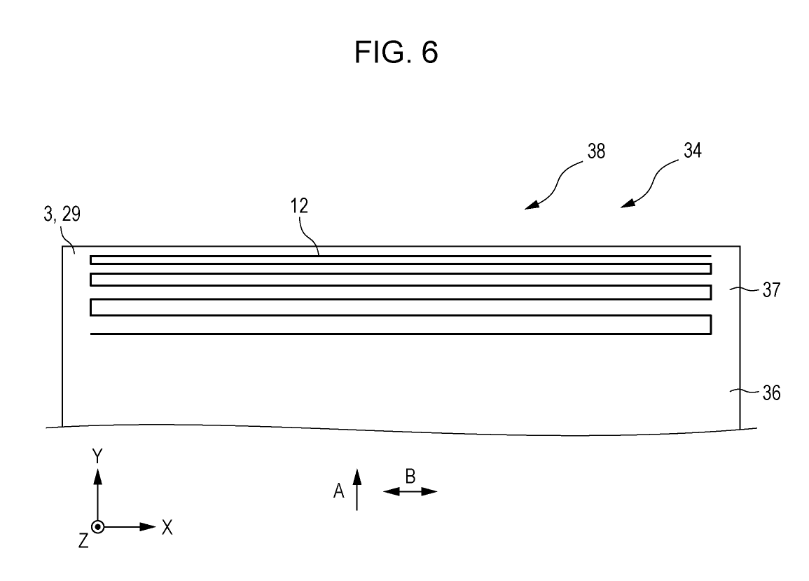

### FIG. 6

FIG. 6 is a schematic plan view illustrating the after-heater 34 serving as the heater 12 which is a main portion of the printing apparatus 1 of the second embodiment, and corresponds to FIG. 4 of the printing apparatus 1 of the first embodiment.

Further, the printing apparatus 1 of this embodiment has the same configuration as the printing apparatus 1 of the first embodiment except for the configuration of the after-heater 34.

As illustrated in FIGS. 4 and 5, the after-heater 34 of the printing apparatus 1 of the first embodiment has a configuration in which the heater 12 is disposed in both the first portion 36 and the second portion 37.

On the other hand, as illustrated in FIG. 6, the after-heater 34 of the printing apparatus 1 of this embodiment is configured such that the heater 12 is not disposed in the first portion 36, that is, the heat source that heats the first portion 36 is not disposed. This configuration also includes a configuration in which the arrangement density of the heat source that heats the second portion 37 is higher than the arrangement density of the heat source that heats the first portion 36. That is, it suffices if the arrangement density of the heat source that heats the first portion 36 is relatively low, and the configuration in which the heat source that heats the first portion 36 is not disposed also includes a “configuration in which the arrangement density of the heat source that heats the first portion 36 is relatively low”. With such a configuration, the printing apparatus 1 of this embodiment can particularly easily form a configuration in which the arrangement density of the heat source that heats the second portion 37 is higher than the arrangement density of the heat source that heats the first portion 36.

### Third Embodiment

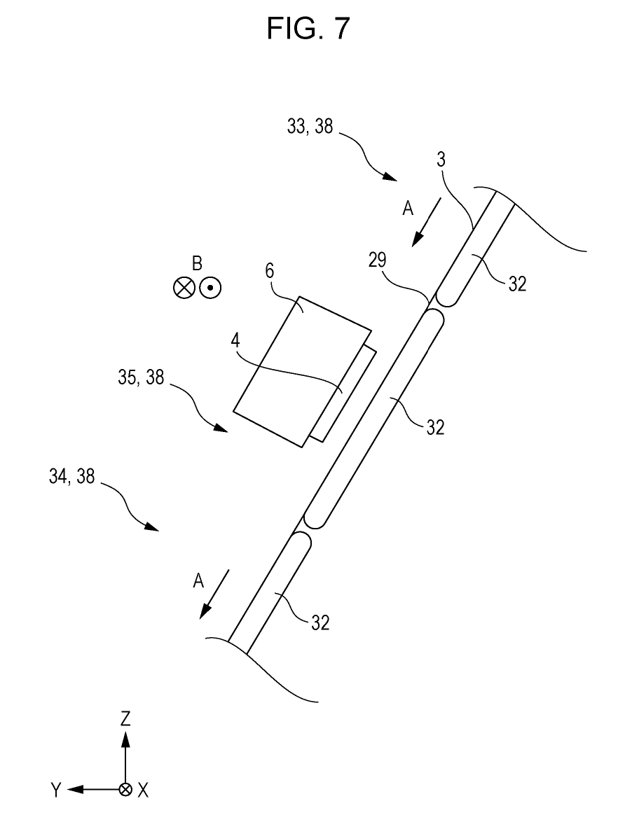

### FIG. 7

FIG. 7 is a schematic side view of a portion of the medium supporting portion 3 illustrating the pre-heater 33, a print heater 35, and the after-heater 34 which are main portions of the printing apparatus 1 of the third embodiment.

Further, the printing apparatus 1 of this embodiment has the same configuration as the printing apparatus 1 of the first embodiment except for the configuration of the medium supporting portion 3.

In the printing apparatus 1 of the first embodiment, as illustrated in FIG. 1, the upstream side portion of the heating region 38 heated by the pre-heater 33 in the transport direction A is low and the downstream side portion in the transport direction A is high, the heating region 38 heated by the print heater is substantially horizontal, and the upstream side portion of the heating region 38 heated by the after-heater 34 in the transport direction A is high and the downstream side portion in the transport direction A is low.

On the other hand, in the printing apparatus 1 of this embodiment, as illustrated in FIG. 7, in any of the heating region 38 heated by the pre-heater 33, the heating region 38 heated by the print heater 35, and the heating region 38 heated by the after-heater 34, the upstream side portion in the transport direction A is high and the downstream side portion in the transport direction A is low.

Therefore, in the printing apparatus 1 of this embodiment, the same configuration as that of the heating region 38 heated by the after-heater 34 of the printing apparatus 1 of the first embodiment is applied to all of the heating region 38 heated by the pre-heater 33, the heating region 38 heated by the print heater 35, and the heating region 38 heated by the after-heater 34 (the internal configuration of each of the convection spaces 32 in FIG. 7 is the same as the internal configuration of the convection space 32 in FIG. 5).

In other words, the printing apparatus 1 of this embodiment is provided with the print heater 35 that serves as the heater 12 and that heats the medium M while printing is performed by the printing unit 4. With such a configuration, in the printing apparatus 1 of this embodiment, while printing is performed by the printing unit 4, in the printing area of the printing unit 4 (the area facing the nozzle forming surface of the printing unit 4), it is possible to heat the medium M while suppressing uneven heating.

Further, the invention is not limited to the above described embodiments, and it goes without saying that it is possible to make various modifications within the scope of the invention described in the claims and that these are included in the scope of the invention.

For example, in the printing apparatus 1 of the first embodiment and the second embodiment, for both of the pre-heater 33 and the after-heater 34, and in the printing apparatus 1 of the third embodiment, for all of the pre-heater 33, the print heater 35 and the after-heater 34, the amount of heat per unit area applied to the second portion 37 is larger than the amount of heat per unit area applied to the first portion 36. However, a configuration including one of the pre-heater 33, the print heater 35, and the after-heater 34 as described above, a configuration including either of the pre-heater 33 and the after-heater 34 in addition to the print heater 35, or the like may be used.

This application claims priority under 35 U.S.C. § 119 to Japanese Patent Application No. 2016-245555, filed Dec. 19 2016. The entire disclosure of Japanese Patent Application No. 2016-245555 is hereby incorporated herein by reference.

What is claimed is:

1. A printing apparatus comprising:
a printing unit that performs printing on a medium; and
a heating unit that heats the medium in a heating region, wherein
the heating region includes a first portion and a second portion having a height lower than the first portion in a direction of gravity, and
the heating unit is configured such that an amount of heat per unit area applied to the second portion is greater than an amount of heat per unit area applied to the first portion.

2. The printing apparatus according to claim 1, wherein the heating region includes a convection space in which air circulates between the first portion and the second portion.

3. The printing apparatus according to claim 2, wherein the convection space has a first surface along a support surface of the medium and a second surface parallel to the first surface.

4. The printing apparatus according to claim 2, wherein the convection space includes an air blowing unit.

5. The printing apparatus according to claim 1, wherein the heating unit is configured such that an arrangement density of a heat source that heats the second portion is higher than an arrangement density of a heat source that heats the first portion.

6. The printing apparatus according to claim 5, wherein the heating unit does not include the heat source that heats the first portion.

7. The printing apparatus according to claim 1, further comprising, as the heating unit, a pre-heater that heats the medium before printing is performed by the printing unit.

8. The printing apparatus according to claim 1, further comprising, as the heating unit, a print heater that heats the medium while printing is performed by the printing unit.

9. The printing apparatus according to claim 1, further comprising, as the heating unit, an after-heater that heats the medium after printing is performed by the printing unit.

10. A heating method for a printing apparatus that includes a printing unit that performs printing on a medium and a heating unit that heats the medium in a heating region including a first portion and a second portion having a height lower than the first portion in a direction of gravity, the method comprising:
heating the medium with the heating unit such that an amount of heat per unit area applied to the second portion is greater than an amount of heat per unit area applied to the first portion.
